(19) United States
(12) Patent Application Publication
(10) Pub. No.: US 2009/0320540 A1
(43) Pub. Date: Dec. 31, 2009

(54) BOLT SEAL

(75) Inventor: Robert E. Stone, Upland, IN (US)

Correspondence Address: BAKER & DANIELS LLP, 202 South Michigan Street, Suite 1400, South Bend, IN, 46601, US

(73) Assignee: E. J. BROOKS COMPANY, Livingston, NJ (US)

(21) Appl. No.: 12/212,687

(22) Filed: Sep. 18, 2008

Related U.S. Application Data
(60) Provisional application No. 61/133,520, filed on Jun. 30, 2008.

(51) Int. Cl. E05B 39/02

(52) U.S. Cl. 70/440

(57) ABSTRACT

A sealing device is provided that includes a bolt having a shaft, a tapered end and a circumferential groove; a lock body having an open end leading into a bore; an overmold substantially surrounding the lock body and including an aperture aligned with the open end of the lock body; a lock ring located in the bore of the lock body; and a washer having a hole aligned with the aperture in the overmold and the opening in the lock body and located between the overmold and the lock ring, the lock ring including a plurality of spokes extending inwardly from an outer ring portion. Some of the spokes can include an inner flange extending generally perpendicular to the spoke, and the inner flanges form a non-continuous inner ring portion.

This application claims the benefit of U.S. Provisional Patent Application Ser. No. 61/133,520 filed Jun. 30, 2008, the complete disclosure of which is hereby expressly incorporated by reference.

### BACKGROUND OF THE INVENTION

The subject invention relates to security devices, and in particular, to security seals that incorporate a bolt and lock body.

It is well known to use security seals in the shipping industry to provide tamper resistant and tamper indicating closures for a variety of shipping containers and receptacles. For example, it is common to place one or more security seals on the exterior of the shipping container through a hasp or other hardware after the contents of the container have been verified.

For numerous reasons a shipper would be required to seal a container after the contents had been placed therein. For example, in international shipping, customs may require that the freight container be sealed. In addition, in domestic shipping, it is often desirable to seal the freight container to prevent tampering or theft of the contents.

As such, it is desirable to have a security seal that both discourages and prevents unauthorized opening of the container and further provides an indication if the container has been opened during transportation. Accordingly, if a seal is broken, it will enable the recipient to readily determine that the container has been opened and may take appropriate action, such as rejecting the shipment or evaluating what is missing or tampered with.

There are varieties of different types of container seals, and some incorporate cables or plastic ties that cannot be removed once locked without breaking the seal or cutting the cable or tie. Other seals incorporate a bolt and are often known as a bolt seal. One example of a bolt seal is disclosed in U.S. Patent Application Publication No. 2007/0007776 A1 to Beard et al. The bolt seal in Beard et al. utilizes a bolt having a shaft and an enlarged head at one end and a tapered end at the other end. It is common for such bolts to include a circumferential groove adjacent the tapered end. The bolt seal also includes a cover surrounding a locking body. The locking body includes a stepped pair of grooves, and a locking ring is located in the grooves and configured to lock with the groove adjacent the tapered end of the bolt.

Another locking seal device is disclosed in U.S. Pat. No. 4,690,443 to Brammall. The device in Brammall includes a bolt having a U-shaped shaft and an enlarged head on one end, a tapered end on the opposite end, and a circumferential groove adjacent the tapered end. The device also includes a lock body having a body member with an annular recess therein and a retainer having a hole therethrough and fixed to the body to overlie the recess. A pair of locking jaws are supported above the bottom of the recess and are biased together. In one aspect, the recess is tiered to define a shoulder upon which the locking jaws rest, and an elastic O-ring extends around the locking jaws to bias them together.

Another sealing device is disclosed in U.S. Pat. No. 7,226,095 B2 to Huang. As with the devices discussed above, the sealing device in Huang also includes a bolt having a shaft and an enlarged head at one end, and the other end is tapered with a circumferential groove located adjacent the tapered end. The sealing device further includes a cylindrical metal barrel and an overmolded plastic sleeve surrounding the barrel. The device also includes a metal disk at the bottom of the overmolded plastic sleeve and a wire clip designed to spring and lock into the circumferential groove of the bolt when the bolt is inserted in the barrel to prevent the bolt from being subsequently withdrawn therefrom.

Other examples of bolt seals are found in U.S. Pat. Nos. 3,975,040 to Van Gompel; 4,626,009 to Burneft et al.; and 4,936,612 to Kohn.

It is an object of the subject invention to provide an improved bolt seal including a unique combination of lock ring, washer, lock body, and overmold.

### SUMMARY OF THE INVENTION

In one embodiment of the invention, a sealing device is provided that includes a bolt having a shaft, a tapered end and a circumferential groove; a lock body having an open end leading into a bore; an overmold substantially surrounding the lock body and including an aperture aligned with the open end of the lock body; a lock ring located in the bore of the lock body; and a washer having a hole aligned with the aperture in the overmold and the opening in the lock body and located between the overmold and the lock ring.

The lock ring may include a plurality of spokes extending inwardly from an outer ring portion with at least some of the spokes including an inner flange extending generally perpendicular to the spokes so that the inner flanges form a non-continuous inner ring portion.

The lock body may have a generally cylindrical configuration including a closed end opposite the opening with a plurality of axially extending ridges formed along an inner surface of the bore. The lock body may also include radially extending ridges on an inner surface of the closed end. Some of the axially extending ridges and radially extending ridges may intersect at a bottom of the bore and may include a central hub-like ridge from which the radially extending ridges extend. The hub-like ridge may include a central opening. The lock body may also have a counterbore above the axially extending ridges, and there may be twice as many axially extending ridges as radially extending ridges.

The overmold may have a hollow interior and partially closed ends. The overmold may also have a central opening at one end and a plurality of external cavities surrounding the central opening, and the other end of the overmold may have a tapered central hole extending into the interior. The lock body can also include scallops in a side wall surrounding the open end. The lock body can also include an annular lip extending around the counterbore. The lock ring can be located at the top of the axially extending ridges, and the washer is located over the lock ring in the counterbore.

### BRIEF DESCRIPTION OF THE DRAWINGS

The above-mentioned and other features and objects of this invention and the manner of obtaining them will become more apparent and the invention itself will be better understood by reference to the following description of embodiments of the present invention taken in conjunction with the accompanying drawings, wherein:

FIG. 1 is a perspective view of a sealing device in accordance with one embodiment of the invention;

FIG. 2 is a side view of the sealing device of FIG. 1;

FIG. 3 is a cross sectional view of the sealing device of FIG. 1 taken along line 3-3 of FIG. 2;

FIG. 4 is a perspective view of one embodiment of a bolt for use with the sealing device of FIG. 1;

FIG. 5 is an enlarged view of the area of the bolt indicated as 5 in FIG. 4;

FIG. 6 is an enlarged view of the area of the bolt indicated as 6 in FIG. 4;

FIG. 7 is an end view of the bolt of FIG. 4;

FIG. 8 is an enlarged view of a portion of a circumferential groove indicated as 8 in FIG. 5;

FIG. 9 is a perspective view of one embodiment of a lock body assembly of the sealing device of FIG. 1;

FIG. 10 is an end view of the lock body assembly of FIG. 9;

FIG. 11 is a cross sectional view of the lock body assembly taken along line 11-11 of FIG. 10;

FIG. 12 is a perspective view of one embodiment of a lock body for use with the assembly of FIG. 9;

FIG. 13 is a plan view of the lock body of FIG. 12;

FIG. 14 is a perspective cross sectional view of the lock body taken along line 14-14 of FIG. 13;

FIG. 15 is a cross sectional view of the lock body taken along line 15-15 of FIG. 13;

FIG. 16 is a cross sectional view of the lock body taken along line 16-16 of FIG. 13;

FIG. 17 is an enlarged view of a portion of the lock body indicated as 17 in FIG. 13;

FIG. 18 is an enlarged view of a portion of the lock body indicated as 18 in FIG. 13;

FIG. 19 is an enlarged view of a portion of the lock body indicated as 19 in FIG. 16;

FIG. 20 is an enlarged view of a portion of the lock body indicated as 20 in FIG. 15;

FIG. 21 is a perspective view of one embodiment of an overmold for use with the lock body assembly of FIG. 9;

FIG. 22 is an end view of the overmold of FIG. 21;

FIG. 23 is a cross sectional view of the overmold taken along line 23-23 of FIG. 22;

FIG. 24 is a cross sectional view of the overmold taken along line 24-24 of FIG. 22;

FIG. 25 is an end view of the overmold from the opposite end shown in FIG. 22;

FIG. 26 is a perspective view of one embodiment of a lock ring for use with the lock body assembly of FIG. 9;

FIG. 27 is a plan view of the lock ring of FIG. 26;

FIG. 28 is a side view of the lock ring of FIG. 26;

FIG. 29 is a plan view of one embodiment of a washer for use with the lock body assembly of FIG. 9; and

FIG. 30 is a side view of the washer of FIG. 29.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the invention, reference will now be made to the embodiments illustrated in the drawings, which are described below. It will nevertheless be understood that no limitation of the scope of the invention is thereby intended. The invention includes any alterations and further modifications in the illustrated devices and described methods and further applications of the principles of the invention, which would normally occur to one skilled in the art to which the invention relates.

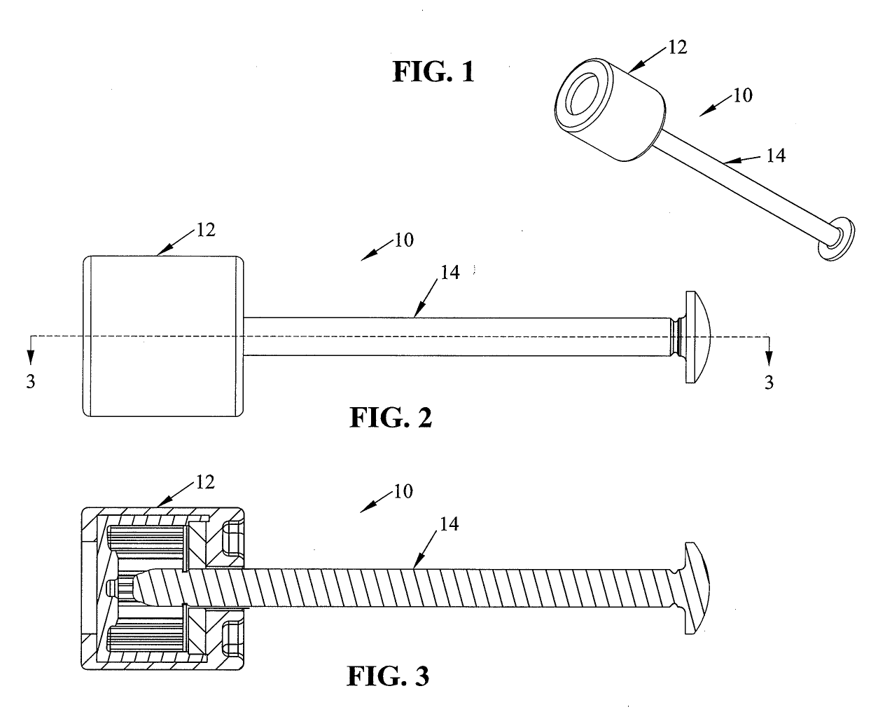

Referring now to FIGS. 1-3, one embodiment of a sealing device in accordance with the subject invention is generally indicated as 10. Sealing device 10 includes a lock body assembly, generally indicated as 12, and a locking bolt, generally indicated as 14.

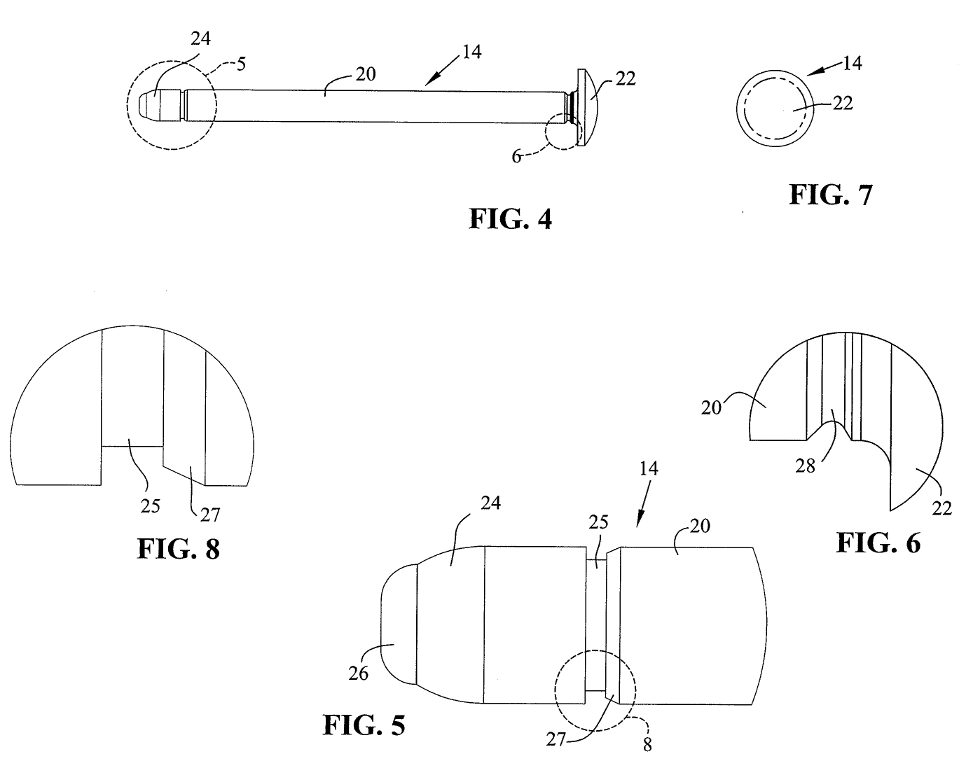

Now referring to FIGS. 4-8, the details of bolt 12 are shown in greater detail. Bolt 12 includes a shaft 20, an enlarged head 22 at one end thereof, and a tapered end 24 at the other end. Bolt 12 also includes a circumferential groove 25 located adjacent tapered end 24 (as best shown in FIG. 5), and a somewhat rounded nose 26 at the tip of end 24. Please note that tapered end 24 may include a slight convexity, as best shown in FIG. 5. In addition, note that one wall of groove 25 may include a tapered end or chamfer transition 27 to shaft 20. Bolt 12 also includes a circumferential groove 28 adjacent enlarged head 22, as best shown in FIG. 6. Bolt 12 may be manufactured from a hardened steel, such as 1038, or other suitable material.

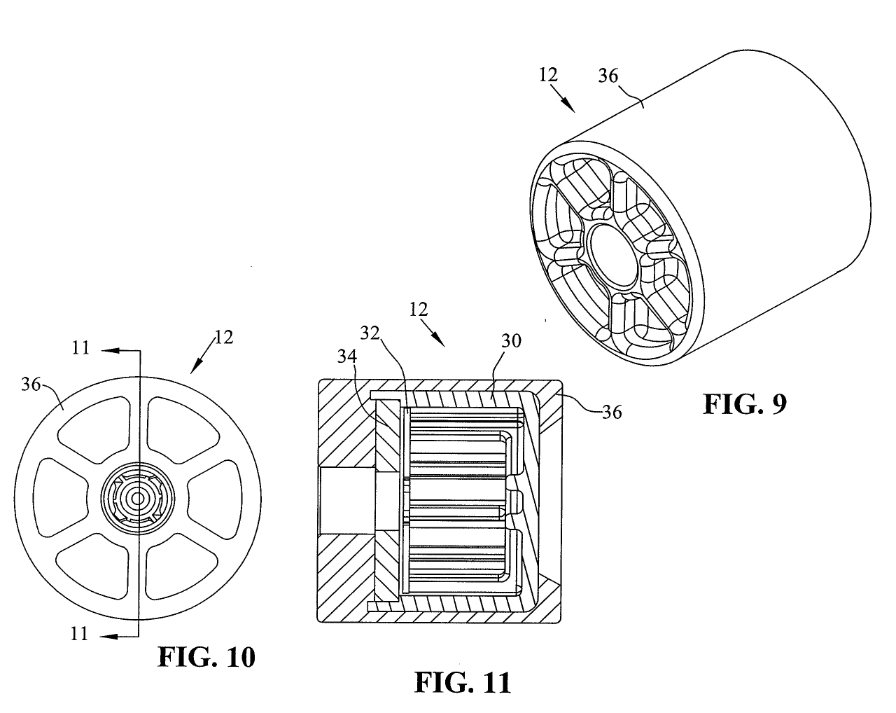

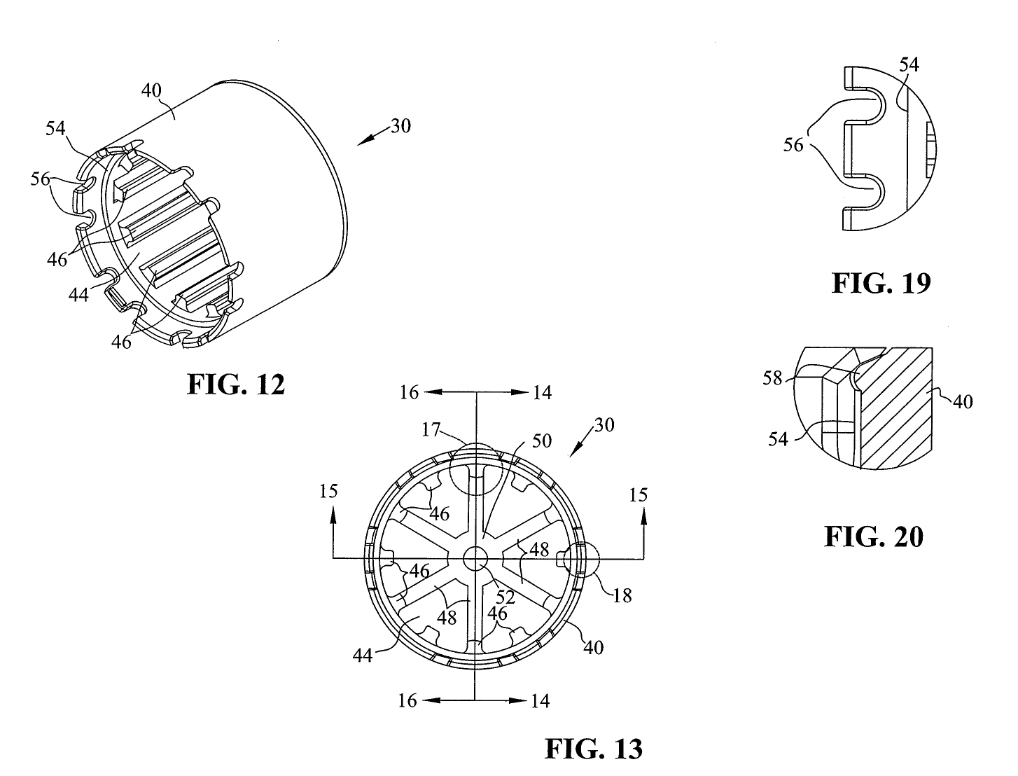

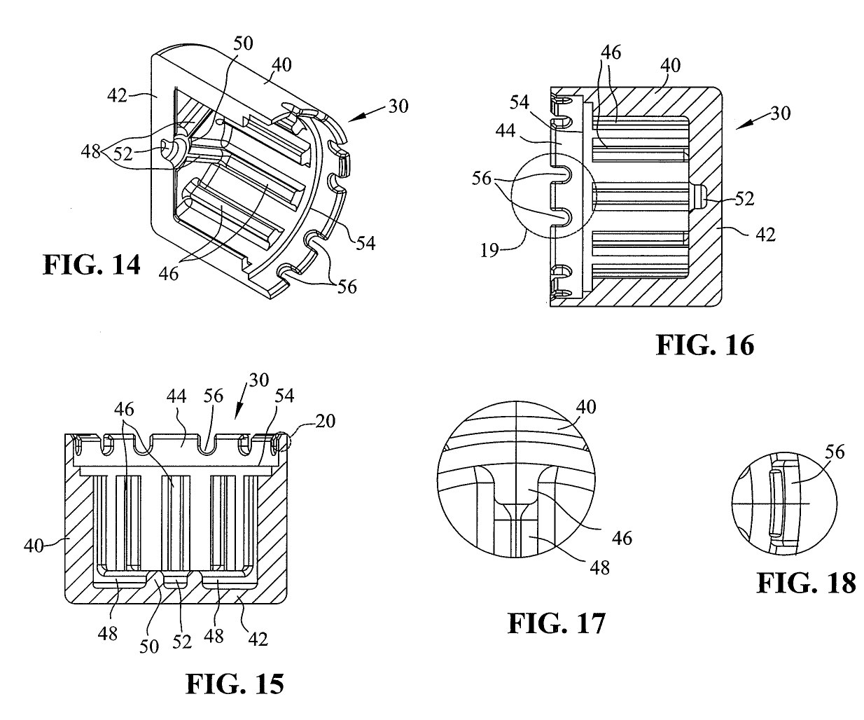

Details of lock body assembly 12 are shown in FIGS. 9-11. Lock body assembly 12 includes a lock body 30, a lock ring 34, and an overmold 36. Referring now to FIGS. 12-20, details of lock body 30 are shown. Lock body 30 may be injection molded from an ABS plastics or other known suitable materials/or methods of manufacture can be used. Lock body 30 has a generally hollow cylindrical configuration and includes a side wall 40, a bottom wall 42 at one end of the side wall, and an open end 44 at the opposite end. The lock body also includes a plurality of equally spaced axially extending ridges 46 projecting from an inner surface of side wall 40. In addition, lock body 30 includes a plurality of equally spaced radially extending ridges 48 on an inner surface of bottom wall 42. Ridges 48 extend from or intersect a central hub-like ridge 50 on bottom wall 42, and a central opening 52 is located in hub-like ridge 50. In the embodiment shown, there are twice as many axially extending ridges 46 as radially extending ridges 48, and ridges 48 intersect corresponding ridges 46 at the bottom of side wall 40, as best shown in FIGS. 14 and 15.

Lock body 30 also includes a counterbore 54 in side wall 40 adjacent opening 44, and further includes scallops or slots 56 at the top end of side wall 40. Also, lock body 30 includes an annular locking lip 58 extending around the upper end of side wall 40 and counterbore 54 (as best shown in FIG. 20) for retaining lock ring 32 and washer 34 in lock body 30 as discussed below.

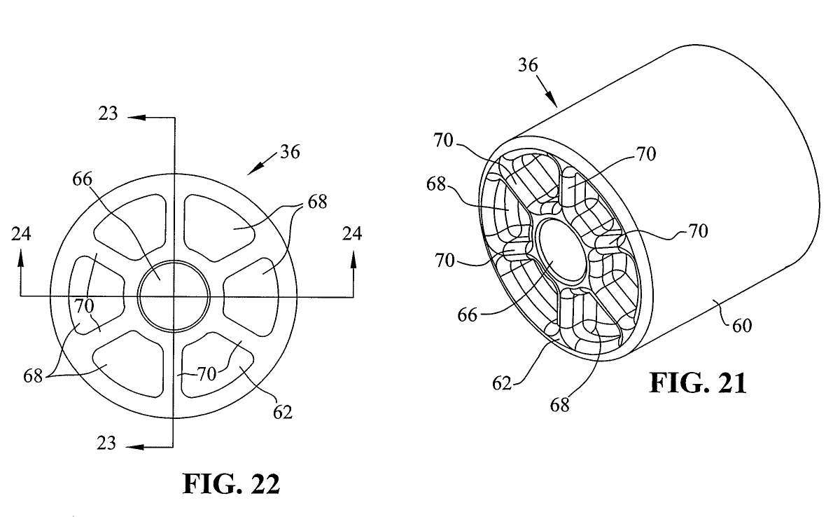

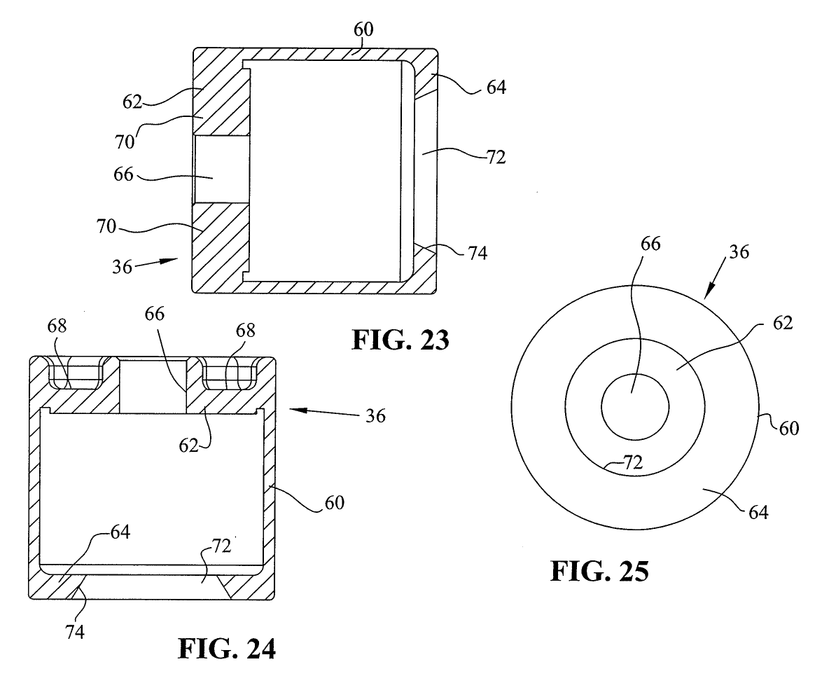

Referring now to FIGS. 21-25, details of overmold 36 are shown. Overmold 36 may be molded from a polypropylene or made using other known suitable materials or methods. Overmold 36 has a generally hollow cylindrical configuration and includes a side wall 60, one partially enclosing end wall 62, and another partially enclosing end wall 64. End wall 62 includes a central opening 66 and a plurality of external cavities 68 surrounding central opening 66. A plurality of spokes 70 extend between cavities 68. End wall 64 66 includes a central opening 72, which may include an annular taper or chamfer 74.

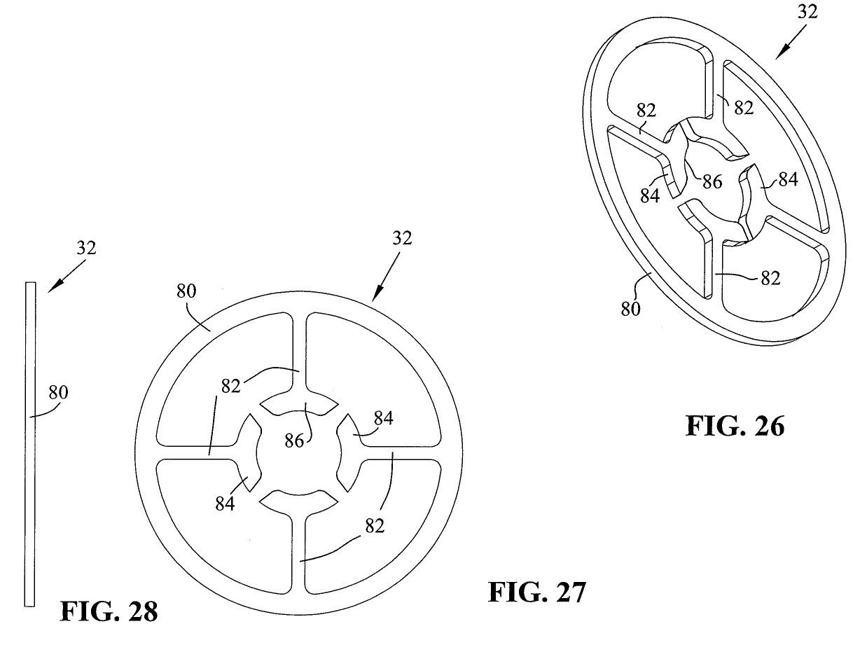

Details of lock ring 32 are shown in FIGS. 26-28. Lock ring 32 can be made from a stamped, high tensile banding or manufactured using other known suitable materials or methods. Lock ring 32 includes an outer ring-like portion 80 and a plurality of spokes 82 extending inwardly from ring-like portion 80. Lock ring 32 also includes inner flanges 84 extending generally perpendicular to spokes 82. Flanges 84 form a non-continuous inner ring portion 86.

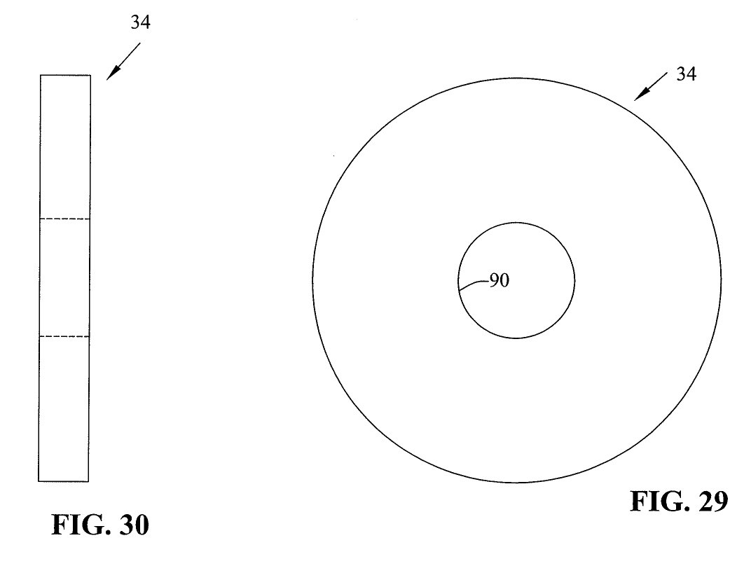

Now referring to FIGS. 29-30, enlarged views of washer 34 are shown. Washer 34 has a generally flat disk-shaped configuration and includes a central hole 90. Washer 34 can be stamped from a cold rolled steel or made using other suitable materials or methods.

To assemble the lock body assembly 12, lock ring 32 is placed in the open end 44 of lock body 30 and bearing upon the end of axially extending ridges 46. Then, washer 34 is placed in counterbore 54 over lock ring 32 and is held in place by locking lip 58. After the lock ring 32 and washer 34 are in place, overmold 36 can be molded around or otherwise fixed around lock body 30.

In operation, the tapered end 24 of bolt 14 is inserted through opening 66 in overmold 36 through opening 90 of washer 34 and inside non-continuous inner ring portion 86 of lock ring 32. The non-continuous ring portion 86 of lock ring 32 is can flex allowing shaft 20 of bolt 14 to enter into and expand the inner ring portion opening; however, when circumferential groove 25 encounters ring-like portion 86, the tensile stress in the lock ring will cause the inner ring portion 86 to snap into the circumferential groove 25. The right angle wall adjacent circumferential groove 25 towards the tapered end will thereby prevent bolt 14 from being removed or otherwise pulled out of lock body assembly 12. As such, the only way to remove bolt 14 is to cut the bolt or destroy lock body assembly 12, thereby providing evidence of tampering.

It should also be appreciated that the cavities 68 around overmold 36 can be used to provide a grip on the lock body assembly. One use thereof can be to prevent the lock body from rotating. It should further be appreciated that the cavities and spokes in the overmold as well as the axial and vertical ridges in the lock body provide a unique configuration providing both weight reduction and strength/rigidity.

While the invention has been taught with specific reference to these embodiments, one skilled in the art will recognize that changes can be made in form and detail without departing from the spirit and scope of the invention. Therefore, the described embodiments are to be considered, therefore, in all respects only as illustrative and not restrictive. As such, the scope of the invention is indicated by the following claims rather than by the description.

1. A sealing device including:
a bolt having a shaft, a tapered end and a circumferential groove;
a lock body having an open end leading into a bore;
an overmold substantially surrounding said lock body and including an aperture aligned with said open end of said lock body;
a lock ring located in said bore of said lock body; and
a washer having a hole aligned with said aperture in said overmold and said opening in said lock body and located between said overmold and said lock ring.

2. The sealing device as set forth in claim 1, wherein said lock ring includes a plurality of spokes extending inwardly from an outer ring portion.

3. The sealing device as set forth in claim 2, wherein at least some of said spokes include an inner flange extending generally perpendicular to said spokes.

4. The sealing device as set forth in claim 3, wherein said inner flanges form a non-continuous inner ring portion.

5. The sealing device as set forth in claim 1, wherein said lock body has a generally cylindrical configuration including a closed end opposite said open end.

6. The sealing device as set forth in claim 5, wherein said lock body includes a plurality of axially extending ridges projecting from an inner surface of said bore.

7. The sealing device as set forth in claim 6, wherein said lock body includes radially extending ridges on an inner surface of said closed end.

8. The sealing device as set forth in claim 7, wherein at least some of said axially extending ridges and some of said radially extending ridges intersect at a bottom of said bore.

9. The sealing device as set forth in claim 7, wherein said lock body includes a central hub-like ridge from which said radially extending ridges project.

10. The sealing device as set forth in claim 9, wherein said hub-like ridge includes a central opening.

11. The sealing device as set forth in claim 6, including a counterbore above said axially extending ridges.

12. The sealing device as set forth in claim 7, wherein there are twice as many axially extending ridges as radially extending ridges.

13. The sealing device as set forth in claim 1, wherein said overmold has a hollow interior and partially closed ends.

14. The sealing device as set forth in claim 13, wherein one of said partially enclosed ends of said overmold has a central opening and a plurality of external cavities surrounding said central opening.

15. The sealing device as set forth in claim 14, wherein said other end of said overmold has a tapered central hole extending into said central bore.

16. The sealing device as set forth in claim 1, wherein said lock body includes scallops in a side wall surrounding said open end.

17. The sealing device as set forth in claim 11, wherein said lock body includes an annular lip extending around said counterbore.

18. The sealing device as set forth in claim 17, wherein said lock ring is located at the top of said axially extending ridges, and said washer is located over said lock ring in said counterbore.
